(19) United States
(12) Patent Application Publication
(10) Pub. No.: US 2006/0283032 A1
(43) Pub. Date: Dec. 21, 2006

(54) Drafting ruler

(76) Inventor: Yao-Te Yang, Taichung County (TW)

Correspondence Address: BIRCH STEWART KOLASCH & BIRCH, PO BOX 747, FALLS CHURCH, VA, 22040-0747, US

(21) Appl. No.: 11/155,578

(22) Filed: Jun. 20, 2005

(51) Int. Cl. B43L 13/02

(52) U.S. Cl. 33/419

(57) ABSTRACT

The invention discloses a drafting ruler that includes a straight ruler, a parallel ruler and a protractor, and the straight ruler includes a groove with a scale at the middle and an arc fixing groove using an end of the groove as the center. The protractor includes a semicircular protrusion corresponding to the fixing groove at the center of said straight ruler for movably connecting the straight ruler, such that the protractor can work with the groove of the straight ruler to draw an oblique line with an inclined angle, and can quickly draw several parallel lines or perpendicular lines starting from the mid-point to the length of the line by using the movably and perpendicularly connected straight ruler and parallel ruler, so that users can draw different figures or tables quickly and conveniently.

### FIELD OF THE INVENTION

The present invention relates to a drafting ruler, and more particularly to a drafting ruler that integrates different functions of a protractor, a straight ruler, and a parallel ruler for drawing various different lines.

### BACKGROUND OF THE INVENTION

The common drafting tools such as a straight ruler, a protractor and a set-square are used to assist users to draw various different lines. However, using the aforementioned drafting tools to draw lines may have the following problems:

1. If a user wants to draw an oblique line with an inclined angle, the user has to use a protractor to define the two end points of the oblique line first, and then uses a straight ruler to joint the two end points to complete drawing an oblique line with an inclined angle. However, the foregoing drawing method requires using a protractor and a straight ruler alternately, and thus making the drafting inconvenient.

2. If a user wants to draw parallel lines or perpendicular lines to create a form or a table, the user has to use two straight rulers (or set-squares). One of the straight rulers is used as a base, and the other straight ruler is pressed perpendicularly against the straight ruler, while shifting the straight ruler on a piece of drawing paper, so as to draw several parallel lines or perpendicular lines. However, it takes too much time to draw the lines or figures by the foregoing drafting method. Furthermore, if the user has not pressed the two straight rulers properly perpendicular to each other, the lines so drawn will not meet the standard size or good looking.

Therefore, there are drafting rulers that integrate a straight ruler and a protractor, but such drafting ruler does not provide users the functions of drawing parallel lines or perpendicular lines easily. The drafting ruler of this sort simply combines a protractor with a straight ruler. If a user wants to use this drafting ruler to draw an oblique line with an inclined angle, the user cannot start drawing the oblique line from the middle of the ruler to the length of oblique line, and thus this kind of drafting ruler is inconvenient to use, and improvements are needed.

### SUMMARY OF THE INVENTION

The primary objective of the present invention is to provide a drafting ruler that allows users to draw different lines quickly and conveniently.

To achieve the foregoing objective, the present invention adopts a drafting ruler comprising a straight ruler, a parallel ruler and a protractor, wherein the straight ruler has a scale disposed along its edges and an end extended into another end to form a groove, and the groove has a groove scale along its edges, and the straight ruler uses an end of the groove as the center to form an arc fixing groove. The parallel ruler has a scale along its edges and a connecting groove passing from one side to the other side and is disposed at the long side of the parallel ruler for movably coupling the straight ruler and parallel ruler perpendicular with each other. The protractor is a semicircular rule with a degree calibration on it, and its center forms a central recession. The central recession is used as the center to form a semicircular protrusion corresponding to the fixing groove of the straight ruler for movably coupling the protractor and the straight ruler.

With the foregoing structural design of the drafting ruler, the following effects can be achieved. The design of the movably coupled straight ruler and parallel ruler allows users to draw several parallel lines and perpendicular lines easily, and the protractor can be used to rotate with respect to the straight ruler and works together with the design of the groove of the straight ruler to draw an oblique line with an inclined angle starting from the middle of the ruler and the length of the line. Thus, the present invention offers an excellent effect for users to draw various different figures quickly and conveniently.

### BRIEF DESCRIPTION OF THE DRAWINGS

FIG. 1 is an exploded view of a drafting ruler of the invention;

FIG. 2 is a perspective view of a drafting ruler of the invention;

FIG. 3 is a schematic view of a drafting ruler when it is in use according to the invention; and

FIG. 4 is another schematic view of a drafting ruler when it is in use according to the invention.

### DETAILED DESCRIPTION OF THE PREFERRED EMBODIMENTS

The technical contents of the present invention will now be described in more detail hereinafter with reference to the accompanying drawings that show various embodiments of the invention.

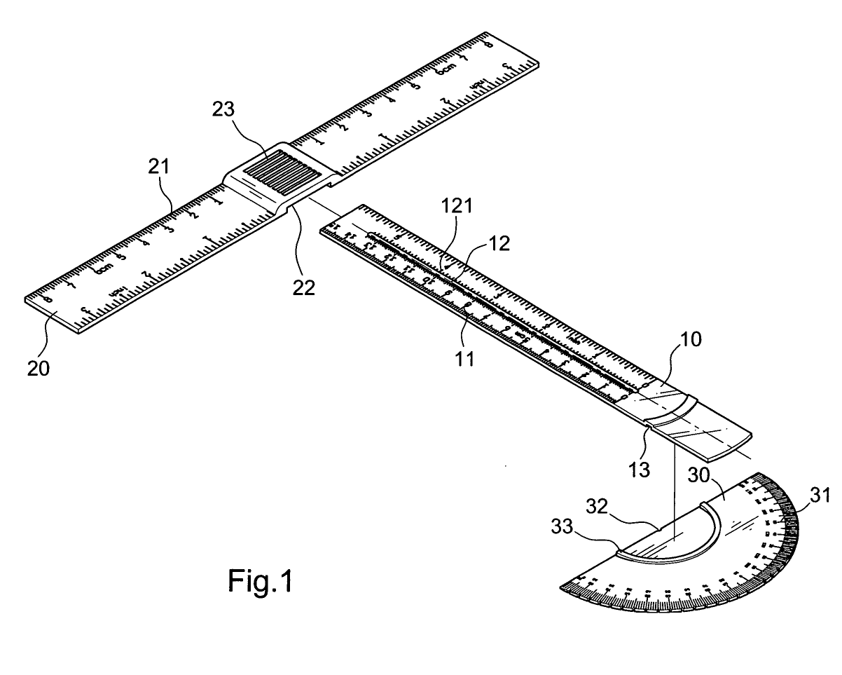

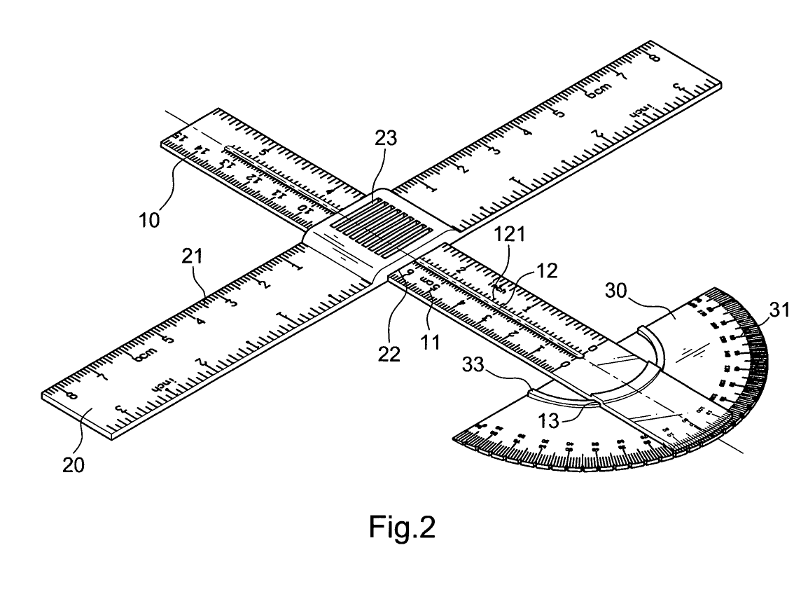

Referring to FIGS. 1 and 2, the drafting ruler of the present invention comprises a straight ruler 10, a parallel ruler 20 and a protractor 30, wherein:

The straight ruler 10 has a scale 11 along its edges, and one end of the straight ruler 10 is extended to another end to form a penetrating groove 12, and the opening of the groove 12 has a groove scale 121 at the periphery of the opening, and the straight ruler 10 uses an end of the groove 12 as the mid-point to form an arc fixing groove 13 at its bottom.

The parallel ruler 20 has a scale 21 at its edges, and a connecting groove 22 penetrating from one side to the other side and disposed at the long side of the parallel ruler 20, such that the straight ruler 10 is movably and perpendicularly coupled to the connecting groove 22 of the parallel ruler 20, and the parallel ruler 20 can be shifted back and forth along the linear direction on the straight ruler 10.

The protractor 30 is a semicircular ruler having an angle calibration 31, and the central position of the protractor 30 forms a central recession 32, and the central recession 32 is used as the center to form a semicircular protrusion 33 corresponding to the fixing groove 13 of the straight ruler 10 and disposed at its top surface, such that the protractor 30 can use the movably connected protrusion 33 and straight ruler 10 and the central recession 32 responding to end position of the groove 12 of the straight ruler 10 to rotate the protractor 30 on the straight ruler 10 by using the central recession 32 as the center.

Further, a plurality of penetrating holes 23 is disposed on the foregoing parallel ruler 20 at a position corresponding to the connecting groove 22, such that after the straight ruler 10 and the parallel ruler 20 are coupled, the contact area between the parallel ruler 20 and the straight ruler 10 can be reduced. When the parallel ruler 20 is shifted back and forth along the straight ruler 10, the friction between the two rulers can be minimized to facilitate their sliding.

Further, the foreign connecting groove 22 of the parallel ruler 20 could be designed as a dovetail tip groove, and the cross-section of the straight ruler 10 is in the shape of a dovetail tip corresponding to the dovetail tip groove. The fixing groove 13 of the straight ruler 10 could be designed as a dovetail tip groove as well, and the protrusion 33 of the protractor 30 is in the shape of a dovetail tip corresponding to the dovetail tip groove so as to give a better effect for the connection between the parallel ruler 20 and the straight ruler 10 (or the straight ruler 10 and the protractor 30).

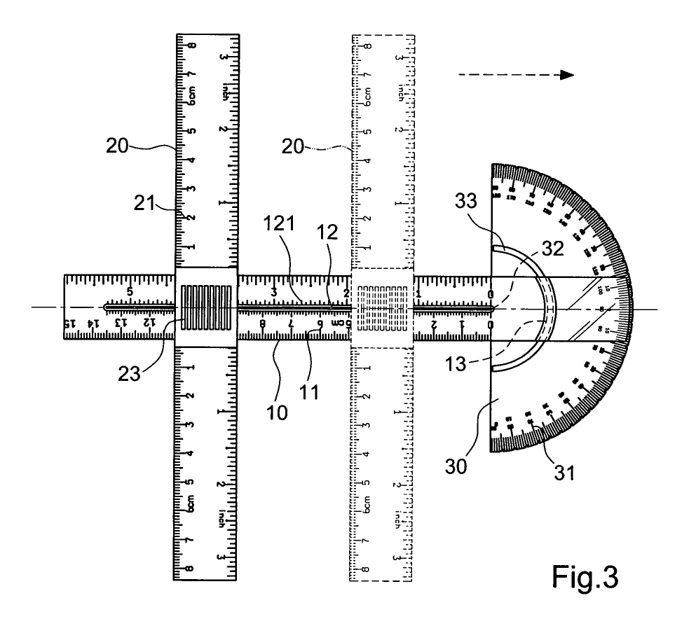

Referring to FIG. 3 for a practical application, if a user wants to draw parallel or perpendicular lines, the design of the straight ruler 10 being perpendicular to the parallel ruler 20 is used to directly draw the perpendicular lines. With the design of sliding the parallel ruler 20 back and forth along the straight ruler 10, the parallel ruler 20 can be used similarly to draw parallel lines. Since the straight ruler 10 and the parallel ruler 20 separately have a scale 11, 21, therefore the length of each line can be drawn accurately. For example, the distance between parallel lines or the actual length of each line can be drawn accurately, and thus users can draw forms or tables quickly.

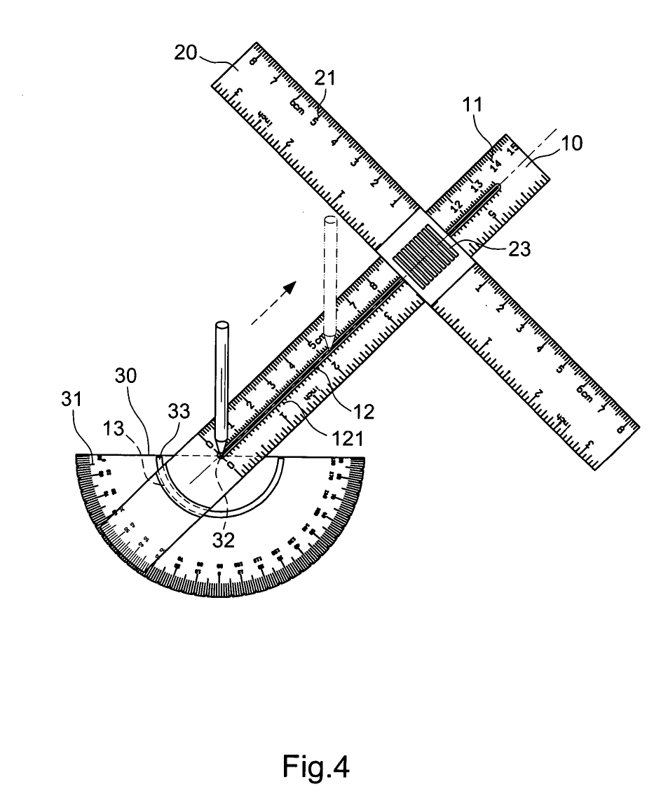

Referring to FIG. 4, if a user wants to draw an oblique line with an inclined angle, the user can directly rotate the protractor 30 on the straight ruler 10 to a certain angle, and then place the tip of a pen into the groove 12 of the straight ruler 10 and the central recession 32 of the protractor 30 to draw the oblique line. The oblique line so drawn will have an inclined angle with respect to the protractor 30. During the process of drawing the oblique line, the oblique line can be drawn by using the central recession 32 (which is the mid-point of the protractor 30) as the starting point, and in the meantime, the groove scale 121 at the periphery of the opening of the groove 12 can be used to define the length or distance of the oblique line easily.

From the structure of the drafting ruler of the present invention, the main characteristics reside on that:

1. Parallel lines and perpendicular lines can be drawn quickly. The design of perpendicularly and movably connected straight ruler 10 and parallel ruler 20 is used, so that users can slide the parallel ruler 20 on the straight ruler 10 to draw the required figure easily.

2. An oblique line with an inclined angle can be drawn easily. The protractor 30 on the straight ruler 10 can be rotated, so that users can directly use the groove 12 of the straight ruler 10 to draw an oblique line with a specific length and an inclined angle, after rotating the straight ruler 10 and the protractor 30. Compared with the traditional way of using the protractor to define two end points of the oblique line first and then connect the two end points by the straight ruler, the drafting ruler of the present invention provides a very convenient way of drawing oblique lines.

In view of the description above, the design of movably connecting the straight ruler 10, parallel ruler 20 and protractor 30 of the drafting ruler allows users to draw parallel lines or perpendicular lines accurately and draw an oblique line with an inclined angle starting from the middle. Therefore, the present invention is applicable for drawing different figures.

What is claimed is:

1. A drafting ruler, comprising:
a straight ruler, having a scale disposed at its edge, and an end of said straight ruler being extended to another end to form a groove, said groove having a groove scale disposed at its periphery, and said straight ruler having an arc fixing groove formed by using an end of said groove as the center;
a parallel ruler, having a scale disposed at its edge, and a connecting groove penetrating from one side to another side and disposed on a long side of said parallel ruler for movably coupling said straight ruler and said parallel ruler; and
a protractor, being a semicircular ruler having a degree calibration and having a central recession formed at the central position of said protractor, and said central recession is used as a center to form a semicircular protrusion corresponding to said fixing groove of said straight ruler for movably coupling said protractor and said straight ruler.

2. The drafting ruler of claim 1, wherein said parallel ruler comprises a plurality of penetrating holes disposed at a position corresponding to said connecting groove.

3. The drafting ruler of claim 1, wherein said connecting groove of said parallel ruler is a dovetail tip groove, and the cross-section of said straight ruler is in the shape of a dovetail tip corresponding to said dovetail tip groove.

4. The drafting ruler of claim 1, wherein said fixing groove of said straight ruler is a dovetail tip groove, and said protrusion of said protractor is in the shape of a dovetail tip corresponding to the dovetail tip groove.
